(19) United States
(12) Patent Application Publication
(10) Pub. No.: US 2004/0146690 A1
(43) Pub. Date: Jul. 29, 2004

(54) Packaging material for electrostatic sensitive devices

(76) Inventor: Robert J. Vermillion, Clayton, CA (US)

Correspondence Address: MCAFEE & TAFT, TENTH FLOOR, TWO LEADERSHIP SQUARE, 211 NORTH ROBINSON, OKLAHOMA CITY, OK, 73102, US

(21) Appl. No.: 10/757,153

(22) Filed: Jan. 14, 2004

Related U.S. Application Data
(63) Continuation of application No. 09/850,368, filed on May 7, 2001, now abandoned.
Application No. 09/850,368 is a continuation of application No. 08/987,101, filed on Dec. 8, 1997, now abandoned.

(51) Int. Cl. B32B 5/12

(52) U.S. Cl. 428/114; 428/323

(57) ABSTRACT

Fiberboard to protect sensitive electronic components and devices from the hazards of ESD (electrostatic discharge) incorporates a homogeneous conductive shielding paperboard having an electrical resistance of less than or equal to one thousand ohms resistance that has been adhered together throughout the corrugation process or lamination process with one or more homogeneous static dissipative linerboards. The liners have a surface resistance range between a targeted 1×10⁷ to 1×10¹¹ at twelve percent relative humidity and 73° Fahrenheit. The static dissipative linerboard and conductive shielding paperboard can be used as static safe packaging cushioning material, shelving liners, dividers, in-plant handlers, specialty static free packaging, and dissipative or shielding paper bags.

### CROSS REFERENCE TO RELATED APPLICATION

This application is a continuation of application Ser. No. 09/850,368, filed May 7, 2001, which is a continuation of application Ser. No. 08/987,101 filed Dec. 8, 1997.

### FIELD OF INVENTION

This invention relates to the field of protective packaging and, in particular, packaging suitable for use with electrostatic sensitive devices. One aspect of the invention relates to an improved fiberboard for use in such packaging and a method for making the improved fiberboard.

### BACKGROUND OF INVENTION

Static Electricity and Packaging

Static electricity is a significant concern in the packaging, handling, manufacturing and distribution of electronic components and computer subassemblies. Electrostatic discharge (ESD) damage is estimated by the ESD Association to cost the electronics industry upwards of $4,000,000,000 annually.

Today's printed circuit boards are very sensitive to static electricity. Advancements in technology over the past 30 years have miniaturized electronics circuitry to the extent that one of today's quarter-sized microprocessors easily has more combined power than large rooms filled with 1950's era super computers of Sandia Labs.

Static electricity is caused by triboelectric charging (two charged objects which generate friction upon contact) that discharges to a conductive or grounded surface. On a larger scale, clouds come into contact with one another and the imbalance of negative and positive ions causes a lightning bolt or high voltage discharge to ground. On the microscopic level, an insulative object could rub against another object to cause an ESD discharge. A relationship between the relative humidity and potential for ESD events can take place anywhere in the world.

Any area is a candidate for static electricity at one time or another. In Southern California, the Santa Ana winds will promote a dry environment and cause countless discharges as one comes into contact with a car door handle or simple electronic circuit board. For instance, the potential for a static event is evident in Colorado where the relative humidity drops below 4% in winter. Insulative surfaces have a greater tendency to hold a charge versus grounded conductors. For example, the following table illustrates the voltage generated on objects at specific relative humidities.

SAMPLE VOLTAGES FROM CHARGING
MILITARY-B-HANDBOOK-263

| | 20% | 80% |
|---|---|---|
| | RH | RH |
| WALKING ACROSS VINYL FLOOR | 12 KV | 250 V |
| WALKING ACROSS SYNTHETIC CARPET | 35 KV | 1.5 KV |
| ARISING FROM FOAM CUSHION | 18 KV | 1.5 KV |
| PICKING UP POLY BAG | 20 KV | 600 V |
| SLIDING STYRENE BOX ON CARPET | 18 KV | 1.5 KV |
| REMOVING MYLAR TAPE FROM PC BOARDS | 12 KV | 1.5 KV |
| SHRINKING FILM ON PC BOARDS | 16 KV | 3 KV |
| TRIGGERING VACUUM SOLDER REMOVER | 8 KV | 1 KV |
| AEROSOL CIRCUIT FREEZER SPRAY | 15 KV | 5 KV |

The ESD damage, which can occur within a very small fraction of a second, can be highly visible causing problems immediately or can take years to be detected. Consequently, latent failure could take place causing a product to work 50% of the time or on an erratic basis, which is known in the industry as a case of the “walking wounded”. This static electricity damage can be extremely costly due to product image, consumer returns, and wasted materials and labor.

Perhaps the most tragic incident associated with static discharge occurred in the 1960s, at Cape Canaveral resulting in the death of three astronauts. This incident was attributed to a static discharge of ignition to the rocket motor squib.

A NASA test method to test materials for triboelectric charge generation and decay was developed as MMA-1 985-79-REV 2 Jul. 15, 1988 R H Gompf, P E, Ph.D. NASA & C.L. Springfield, NASA Chief Materials Testing Branch. Insulative materials would no longer be able to come into close contact with the space vehicles. The following table outlines the electrostatic voltages than can 5 damage electronic devices.

SUSCEPTIBILITY RANGES OF VARIOUS DEVICES
EXPOSED TO ESD CHARGES

| | RANGE OF ESD | |
|---|---|---|
| DEVICE TYPE | SUSCEPTIBILITY | |
| M. R. HEAD ® TECHNOLOGY | 5-50 | VOLTS |
| MOSFET | 100-200 | VOLTS |
| JFET | 140-10,000 | VOLTS |
| CMOS | 250-2,000 | VOLTS |
| SCHOTTKY DIODES, TIL | 300-2,500 | VOLTS |
| BI-POLAR TRANSISTORS | 300-7,000 | VOLTS |
| ECL (FOR HYBRID USE/PC BOARD) | 500 | VOLTS PLUS |
| SCR | 600-100 | VOLTS |

Due to volatile fuels and the potential for explosions on ships and aircraft, the Department of Defense in the late 1970s set standards to protect products and people from the hazards of ESD. The focus was in relationship to handling, storage and packaging of ESD sensitive products. The rush was on to develop materials that would protect sensitive components and devices from static electricity. Conductive enclosures were found to provide a path to a grounded surface and reduce the hazards of triboelectric and high voltage discharges.

In the area of packaging, foil laminated to various forms of paper was found to shield against static electricity when the object could be enclosed. An electrically conductive enclosure or box-like configuration known as a Faraday Cage was found to attenuate or shield objects from static electricity. Later, carbon loaded polymer totes and nickel metalized 3M® shielding bags were known to exhibit shielding properties.

Kraft Paper and Paperboard

The term Kraft is of German origin meaning strength; designates pulp, paper or paperboard produced from wood fibers by the sulfate process.

One type, Cylinder Kraft containerboard, is a multi-ply formation with predominate grain direction of fibers made from a natural light brown like Kraft pulp on a cylinder machine. This type of paper making technology is widely used.

Paperboard relates to a broad classification of materials made of cellulose fibers, primary and recycled wood pulp, recycled paper stock, newsprint, packaging papers, solid and chipboard fibers that can be made into box board, chip board, solid fiber or fiberboard.

Fiberboard is a term describing combined paperboard (corrugated or solid fiber) used to manufacture sheets or containers. It can take two or more paperboard liners and be adhered to a fluted corrugated medium to form corrugation or be of a makeup of two or more paperboard liners that through lamination will form solid fiber or a folding carton material. Boxes are typically formed fiberboard.

Corrugated is a term for “cardboard” box liner(s) and medium that has been bonded together by a corrugator.

Containerboard relates to paperboard components (linerboard, corrugated materials and chipboard) used to manufacture corrugated and solid fiber.

Medium is a term for paperboard material that has been formed into a wave shape or flute structure and is usually buried between one or more linerboards.

Linerboard is a term for paperboard used for the flat outer facings of combined corrugated fiberboard or laminated as the outer facings of fiberboard.

Although corrugated natural Kraft (cardboard) boxes have been found to be antistatic or static dissipative at higher relative humidities, the Kraft paper was not electrically conductive enough to provide the necessary static shielding. While Kraft paper is hygroscopic (absorbs water), the porosity of the surface can make paper dry out in low relative humidities, i.e. below 23% to 30% for bleached white and below 12% to 15% relative humidity for Kraft paper. Accordingly, the material exhibits insulative characteristics but the material will not drain a charge to ground nor prevent a charge from being generated. High areas of electronic manufacturing such as California, Colorado, Arizona, Texas and other states, have problems with low relative humidities. To complicate the issue, air transit of conductive components will cause the packaging to be exposed to conditions of very low relative humidities.

Some organizations rely on Military Standard 81705 to evaluate corrugated materials in adverse transport conditions. According to this method, specimens are placed in a dry oven for 12 days at 160° F. and conditioned in a chamber for 48 hours at 73° F.+/−6° @ 12%+/−3% relative humidity (Standard Conditions for ESD Association). Then the material samples are tested for surface resistance per ESD-S.11.11-1993 in ohms. Kraft paper in itself would not pass ESD-S.11.11-1993 @ standard conditions since paper has been known to exhibit various cut off limits in low relative humidities.

Another problem is that Kraft roll stock is traded between companies and depending upon the amount of virgin fiber that has been pulped in the sulfate process, the paperboard may have too much reducible sulfur. Preferably reducible sulfur will not exceed eight parts per million (per TAPPI 406 om-94). Sulfur can act as a corrosive to electronic devices that could come into contact with the Kraft liner. The cut off for static dissipative materials as measured for surface resistance on an insulative plane is 1.0×10¹¹ ohms and preferably less than 1×10³ ohms for static shielding conductive surfaces.

One of the first primary approaches to make conductively shielding corrugated was to coat Kraft exterior liners or corrugated with a conductive carbon ink which exhibits a surface resistance of 1×10³ ohms for the base coat or coatings. A second or third coating of clearcoat varnish is applied over the carbon ink to reduce rub off (U.S. Pat. Nos. 4,160,503, 4,211,324 and 4,293,070). Due to wear, the carbon particles can rub off and bridge the gap of PC board circuit lines and cause a short. The material with a Kraft medium, which is arched, and the Kraft liner can prevent a drain to ground in low relative humidities per Electronic Industry Association, EIA-541 Appendix F.

In this method +/−1000 volts to +/−100 volts is required to drain to ground in less than 2.0 seconds. Such a material has a very conductive surface resistance that can exhibit “sparking” or a rapid discharge if the container is in an open state and placed on a grounded surface, this type of discharge is known as a Charged Device Model (CDM) hazard. However, U.S. Pat. No. 5,407,714 describes a subsequent technology developed with a basis weight of 42 pounds per thousand square feet (lbs/msf) to 69 pounds per msf. This technology prints the backside of the inner Kraft liner with a highly conductive static shielding layer of carbon black ink. Consequently the ink is buried beneath the Kraft liner and adhered to a Kraft corrugated medium. The Kraft liners are coated with a blue or black dissipative surface with a clear coat dissipative sealer to the exterior. The medium is conventional Kraft paper as found in most boxes. This product has been observed to delaminate between the fluted medium and the interior ink conductive-coated liner. From samplings, it appears that the coating process of the reverse side of the Kraft liner compromises the adhesion process between the medium and the liner interior facings. The corrugated medium is less able to bond to a coated surface as compared to a Kraft uncoated surface. Consequently, the liner separates with relative ease.

One of the first layered technologies to consider CDM safety can be seen in U.S. Pat. No. 4,000,790. It has 6-7 recycled layers of recycled paper that is produced on a cylinder machine. The paper weighs about 54 pounds/msf to 69 pounds/msf. The Kraft wood chips are layered down and the layers are built-up. The fifth or sixth buried layer consists of carbon black to provide shielding against static electricity. The carbon bleeds through the other layers in lesser amounts. Thus, the surface becomes dissipative. A final polyethylene coating is used to reduce severe rub off of carbon particles as found with conductively coated ink liners which could bridge the gap of circuit board and cause a short. However, after use, the lesser amounts of carbon on the surface may still be a means to cause a short.

Another cylinder CDM safe material is being commercially sold under U.S. Pat. No. 4,711,702. While similar to the above, the material has shown to have less internal bond in the layers (weight: about 48 pounds/msf) and the inside portion of the liner is more like Kraft.

Corrugated with Kraft medium may pose a problem with suppressed charges or hidden charges known as “Crypto” charges that can develop in lower relative humidities. In addition, taking a flat piece of the corrugated board and subjecting it to a static decay from +/−1000 volts to +/−100 volts at standards conditions could exhibit a decay of more than 2.0 seconds.

U.S. Pat. No. 5,205,406 relates to a method in which a thin metalized highly conductive film to be laminated to chipboard, solid fiber or Kraft liner.

The metalized layer is coated with a low-density polyethylene film, which is subjected to high-energy electron beam radiation. The surface is dissipative and the metalized film is conductive. The material can shield but it has been observed to have a slow drain to ground at standard conditions with the solid fiber material. The paper that is sandwiched between the laminated liners has been observed to have difficulty in draining charges away in less than 2.0 seconds. Some samplings of the material as they have been repulped to determine repulpability have contained metallic particles. The original versions of foil laminated corrugated have not been in wide use due to the problems associated with repulpability.

U.S. Pat. No. 5,637,377 employs an impregnated conductive medium that is cohered as corrugated medium between two blue Kraft coated liners that have been preprinted with two coats of ink composed of carbon and blue copper dissipative ink. Preprinting the liners assists in the uniformity of electrical surface readings by an even application of the ink and varnish over the Kraft liner. A final coating of styrene acrylic polymer or clear coat varnish is printed in two passes onto the drying blue ink. Due to wear and rub off, the conductive particles used in the formulation of the above exterior dissipative liners of this product may be sufficient enough to bridge the gaps of a circuit and cause a short. Wear and tear will eventually expose the Kraft liner, which could become insulative in lower relative humidities.

If one sampling of the Kraft paper is virgin paper, the material may exhibit higher degrees of reducible sulfur contamination than recycled paper. The untreated liner has a severe set back in not being able to maintain static dissipative properties in lower relative humidities, i.e. below 12% to 15%. Differences in test results may also stem from the variance of Kraft liner sources that are widely used in the corrugated industry. Linerboard designated for produce or food packaging could be corrugated into this material.

One current method positions the ESD liner on the inside of the box while exposing the Kraft liner to the outside of the corrugated box or container. This method has been observed to improve static shielding as measured by a high voltage discharge test method. However, during transport on land, sea and air, the relative humidity can drop to less than 4%. Consequently, an untreated Kraft liner would act as an insulator and triboelectric charging could occur by the vibration or movement in transportation where a charge transfer could take place.

In view of the deficiencies of the current technologies, a need exists for a carbonless Charge Device Model (CDM) safe material that has a buried homogeneously static shielding medium. The material would optimally be volume resistance (providing an excellent path or drain to ground), offer a variety of printing options, repulpable, static shielding, gluable and able to form into various combinations. Other advantages over previous technologies is that this product is truly homogeneous for volume resistance, provides an excellent path to ground on a grounded surface, superior durability, carbon free liners, gluability and printing options. The invention can be made into ESD static shielding boxes, bags, dividers and packaging materials. The invention comprises a buried shielding linerboard or medium that is laminated or corrugated to the exterior homogeneous linerboard.

### SUMMARY OF THE INVENTION

Among other aspects, the present invention is based on the surprising discovery that a dissipative paperboard which includes at least one static dissipative substance can be effectively employed in a variety of paper-containing products and, in particular, in those paper products for use with electrostatic sensitive devices. To this end, one aspect of the present invention relates to a dissipative paperboard for use in paper containing products comprising an effective amount of at least one static dissipative substance to provide a desired static dissipative property, wherein the static dissipative substance is homogeneous throughout the dissipative paperboard. The static dissipative paperboard is substantially free of carbon particles.

Moreover, another aspect of the present invention relates to a fiberboard composition comprising at least one conductive paperboard sandwiched between layers of static dissipative linerboard. A static dissipative substance is substantially homogeneously dispersed throughout the static dissipative linerboard. An electrically conductive substance is homogeneously dispersed throughout the conductive paperboard.

Further, the current invention provides a static dissipative paperboard comprising a static dissipative substance homogeneously dispersed throughout the paperboard. The static dissipative paperboard has an electrical resistance between about 1×10⁴ and about 1×10¹¹ ohms at a relative humidity of less than or equal to 12 percent.

Additionally, the current invention provides a conductive paperboard comprising a conducting material homogeneously dispersed throughout the paperboard. The conductive paperboard has an electrical resistance of less than or equal to about 1×10³.

The current invention also provides a method for making recyclable fiberboard. The recyclable paperboard is particularly suited for use in protecting electrostatically sensitive devices from the hazards of electrostatic discharge. The method of the current invention comprises the steps of:

(a) providing a conductive paperboard layer having an electrical resistance of less than or equal to about 1×10³ ohms;

(b) providing linerboard having dissipative electrical resistance of between about 1×10⁴ to about 1×10¹¹ ohms at twelve percent relative humidity; and,

(c) adhering linerboard to at least one side of said conductive paperboard through a heat and starching process.

The paperboard layer has a wave shape and has a sufficient concentration of homogeneously dispersed carbon black such that the paperboard has an electrical resistance of less than or equal to 1×10³ ohms.

Still further, the current invention provides a fiberboard composition comprising at least one conductive paperboard, said conductive paperboard has an electrical resistance equal to or less than about 1×10³ ohms and a basis weight range between about 10 lbs/msf and about 50 lbs/msf. Homogeneously dispersed throughout the conductive paper board is an electrically conductive substance. The fiberboard composition also comprises at least one static dissipative linerboard. The static dissipative linerboard has an electrical resistance between about 1×10⁴ and 1×10¹¹ ohms at a relative humidity of less than twelve percent and less than about 8 ppm of reducible sulfur. Substantially homogeneously dispersed throughout the static dissipative linerboard is a static dissipative substance.

Still further, the current invention provides a conductive paperboard comprising from about 6% to about 10% by weight carbon black dispersed throughout the conductive paperboard. The conductive paperboard has an electrical resistance of less than or equal to about 1×10³ and a basis weight range between about 10 lbs/msf and about 50 lbs/msf.

Finally, the current invention provides a method for making recyclable fiberboard for use in protecting electrostatically sensitive devices from the hazards of electrostatic discharge. The method of the current invention comprises the steps of:

(a) providing a wave shaped conductive paperboard layer having an electrical resistance of less than or equal to about 1×10³ ohms, said conductive paperboard layer comprises carbon black in an amount ranging from about 6% to about 10% by weight and has a basis weight range between about 10 lbs/msf and about 50 lbs/msf;

(b) providing linerboard having dissipative electrical resistance of between about 1×10⁴ to about 1×10¹¹ ohms at twelve percent relative humidity; and,

(c) adhering linerboard to at least one side of said conductive paperboard through a heat and starching process.

### BRIEF DESCRIPTION OF THE DRAWINGS

FIG. 1 shielding Human Body Model (HBM).

FIG. 2 fiberboard.

FIG. 2A cross-section of medium, apex & nadir for starching.

FIG. 2B cross-section of dissipative linerboard.

FIG. 2C fiberboard w/conductive medium sheet perspective.

FIG. 2C1 cross-section of solid fiber or liner (33), (35) & (37) as laminated.

FIG. 2C11 cross-section FIG. 2C111.

FIG. 2C111 fiberboard w/o conductive medium sheet perspective.

FIG. 3 front view dissipative solid fiber.

FIG. 3A front view dissipative/buried conductive solid fiber.

FIG. 3A1 perspective of FIG. 3A dissipative/buried conductive solid fiber.

FIG. 3A11 cross sectional of FIG. 3A1.

FIG. 4 Crumple use of this invention.

### DETAILED DESCRIPTION OF THE PREFERRED EMBODIMENTS

As discussed above, the present invention includes a static dissipative paperboard that can be effectively employed in connection with other paperboard materials. As defined above, linerboard is one form of paperboard material.

The static dissipative paperboard according to the present invention includes a static dissipative substance and a paper-forming substance. Preferably, the static dissipative substance is homogeneously admixed with at least one paper-forming substance during the manufacturing process to yield a homogeneous static dissipative paperboard. The static dissipative paperboard is suitable for use as static dissipative linerboard.

Any static dissipative substances that can be effectively admixed with the paper-forming substance comprising the paperboard can be employed in the present invention. Specific examples of suitable static dissipative substances include Calgon Polymer 261 (known as 2-Propen-1-aminium,N,N-dimethyl-N-2-propenyl-,chloride, homopolymer or poly(diallyldimethylammonium chloride)); Carbowax; or diethanol amide. For the purposes of this disclosure poly(diallyldimethylammonium chloride) will be used when referring to Calgon Polymer 261.

By “paper-forming substance” it is meant any and all substances that are capable of making paper including but not limited to rice paper, pulp, hemp, rags, cotton, textiles, and the like. Moreover, paper-forming materials include both virgin and recycled materials including recycled paperboard, recycled paper, recycled newsprint, and recycled pulp.

Because carbon particles can bridge the gaps of circuit lines, the static dissipative paperboard is preferably free of carbon particles.

By “homogeneously admixed” is meant that the materials are mixed together in a batch or continuous process so as to provide an at least substantially equal distribution throughout the mixture.

The device used to mix the ingredients is not critical to this invention. For example, batch mixing can take place in a Hydrapulper or blender-like device machine.

This process can also aid in ensuring that the dissipative admixture(s) bond to the wood fibers and such. The homogenous admixture of the two components is important in order to provide the desired properties for the resulting composites, e.g., a volume resistivity quality in environments having a low relative humidity, e.g., 9-15% or lower. Further, unlike the prior coated technologies, the paperboard of the current invention reads static dissipative per ANSI/EOS/ESD S.11.11-1993.

The precise technique for producing the inventive dissipative paperboard is not critical to the invention. Suitable techniques for producing the dissipative liner include a Fourdrinier paper making process or batch processes. The techniques include the use of inherently conductive or dissipative polymers that can be mixed in a slurry or hydrapulper and blended together in the paper making process to form paperboard. The combination of two static dissipative liners that are bonded to a fluted static shielding medium, results in the industry's only volume conductive technology.

The dissipative paperboard according to the present invention can be employed in a variety of environments and, in particular, in combination with paper-containing products. The dissipative paperboard according to the present invention is preferably employed in a composite material in combination with at least one conductive shielding paperboard.

Suitable electrically conductive materials include those electrically conductive materials known in the art such as carbon black or inherently conductive polymers.

The desired electrical conductivity is dependent on the desired end use. For example, a static shielding barrier would require a conductivity of less than 1000 ohms or static dissipative exterior liners that have a conductivity of between 10,000 ohms to 1.0×10¹¹ ohms per ANSI/EOS/ESD S.11.11-1993.

The homogeneously conductive medium and homogeneously conductive paperboard described herein each include an electrically conductive substance homogeneously admixed throughout the material to provide a desired electrical conductivity. Such materials are described, e.g., in the definition of a Faraday Cage that required electrical conductivity, which is continuous.

In addition, other paper-containing materials include materials such as rice paper, hemp, rags, cotton, textiles including offshore boxboard liner(s) or paperboard, as well as recycles materials including recycled cardboard, recycled paper, recycled newsprint and the like.

One example of the preferred embodiment of the current invention relates to a composite have a homogeneous conductive shielding layer formed from paperboard sandwiched between juxtaposed first and second faces of static dissipative linerboard. The conductive shielding paperboard has an electrically conductive substance substantially homogeneously admixed therein to impart electrical conductivity to said conductive shielding paperboard. The opposite first and second faces of the static dissipative linerboards have a static dissipative substance substantially homogeneously admixed therein to impart to said linerboard a static dissipative property.

Moreover, the paperboard employed in composites according to the present invention are not necessarily flattened but instead can have a variety of shapes including wave shape as a medium or “wave” fluted (snake like curves) or otherwise known as “D” flute and corrugated medium.

Examples of a suitable wave shape medium is illustrated by a corrugation having apexes and nadirs in an alternating fashion such as that illustrated in the Fiber Box Handbook as A, B, C, D (wave flute), E, F, N, BC, CB, BB, BE, EF, AB, BA, and BF flute of corrugated liners. Moreover, pages 1-118 of the Fiber Box Handbook are incorporated by reference for all purposes.

Further, the above described preferred embodiment can be effectively employed in many applications and may include a multitude of layers of static dissipative paperboard and conductive shielding paperboard.

Examples of other materials, which can be employed in the invention, include the use of small profile fluted or high profile fluted boxboard static shielding containers, shelving liners as micro fluted sheets or singly ply bags. These additional layers can be employed between the dissipative paperboard and the conductive shielding paperboard or can be employed on either or both sides of the various layers.

Moreover, the composites according to the present invention can be made by any technique were recognized in the art including those described in “G A Smook's HANDBOOK FOR PULP & PAPER TECHNOLOGISTS, 1986 and James E. Kline's PAPER AND PAPERBOARD Manufacturing and Converting Fundamentals of 1982.

The composite material including the dissipative liner layers according to the present invention can be used in a variety of environments.

In this regard, the composite materials can be used in any packaging environment. For example, they can be used to make a bin box for storage of, e.g., circuit boards, in plant handlers, e.g., a box with dividers used to move circuit boards from location in a plant to another, dip tube handlers, e.g., a box with dividers that house dip tubes, circuit board mailers, antistatic mats, in board bin boxes, paper bags for enclosing circuit boards, shelf liners, molded pulp containers, e.g., egg cartons and the like and specialized custom ESD shielding containers.

In addition, this invention can effectively replace metalized shielding bags; injection molded totes or metalized encasements.

While the dissipative paperboard according to the present invention can be employed in connection with a variety of products, the specification will now focus on one exemplary embodiment of an ESD box including dissipative fiberboard.

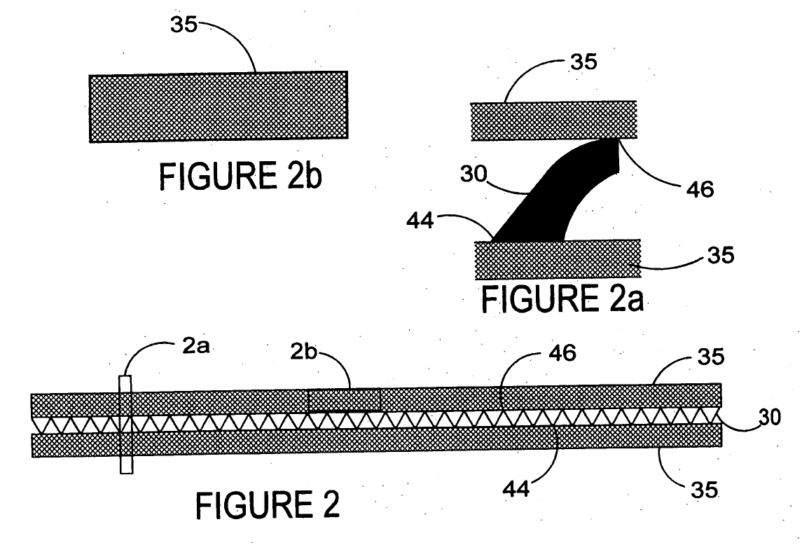

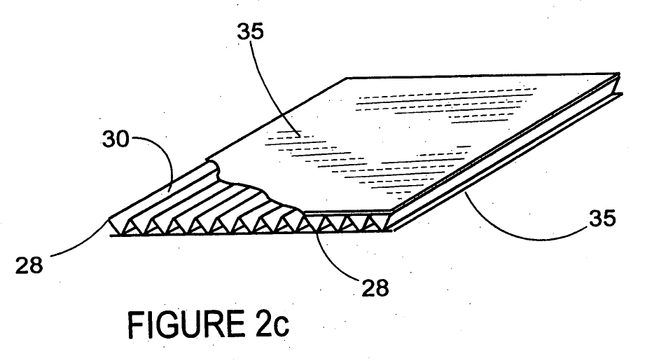

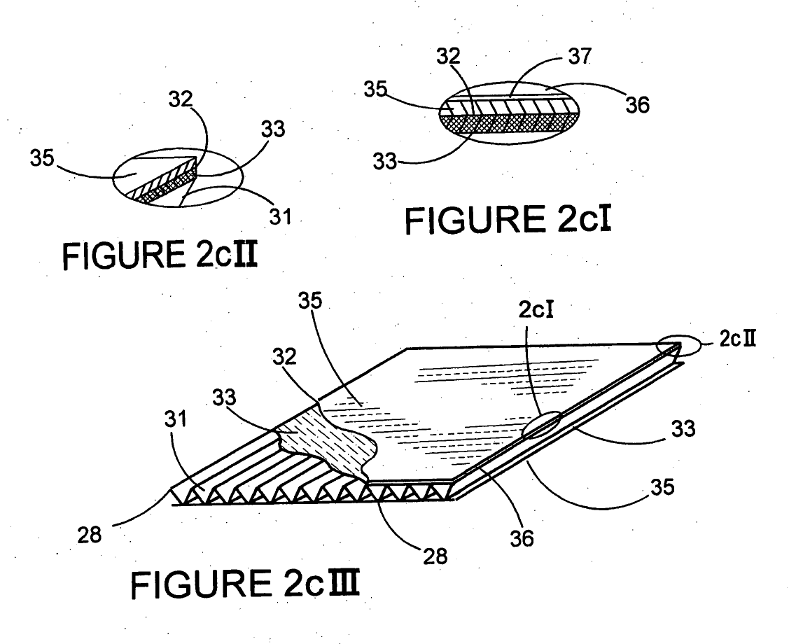

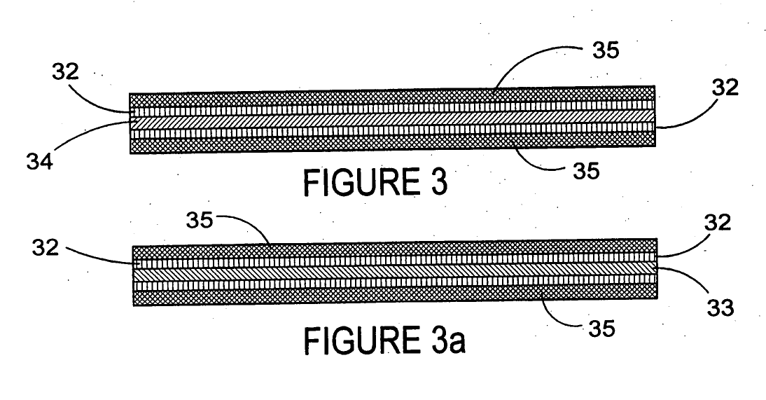

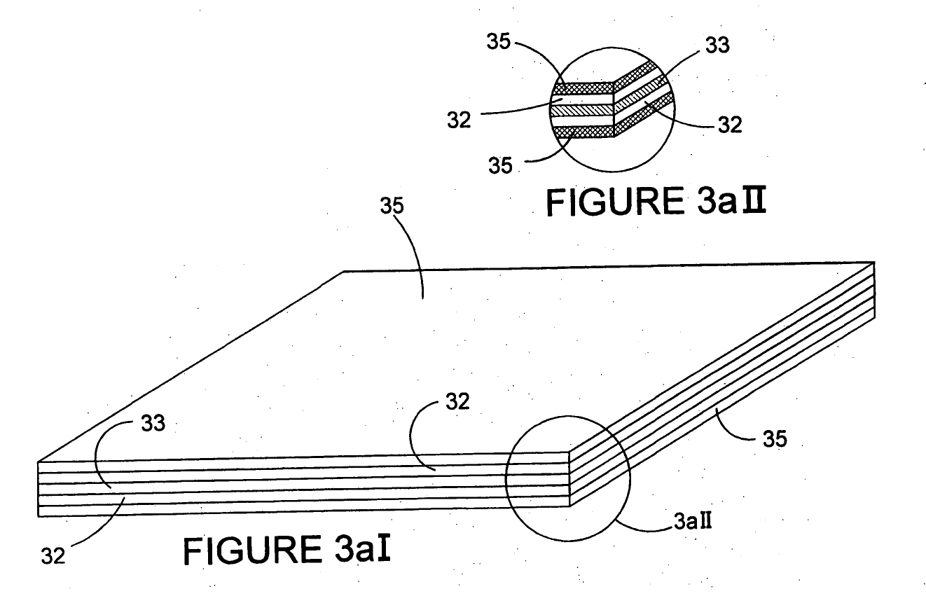

The ESD fiberboard material can be constructed of two of more paperboard liners that are combined through corrugation or lamination. A dissipative linerboard (35) is combined with corrugated or solid fiber (FIGS. 2, 2A & 2B, 3A) having a buried homogeneous conductive medium (30) (FIG. 2A) or conductive paperboard (33) (FIGS. 3A, 3A11). Per standard ESD-S.11.11-1993, the medium can be sufficiently mixed with an electrically conductive material to provide an electrically conductive resistance of less than 1.0×10³ ohms reading.

The dissipative linerboard can be manufactured homogeneously into a special dissipative colored paper admixture of specially formulated ESD imparting chemicals. The linerboard can be made from a homogeneous manufacturing technology that can use a full array of color options and shades since the paperboard is being chemically treated throughout.

For example, the dissipative paperboard can be mixed in a batch with dissipative color pigments or dyes, the dissipative component, e.g., poly(diallyldimethylammonium chloride) in a preferred amount of 0.5%-7.5% (depending upon resistance required and thickness of paper required) or Union Carbide's Carbowax (polyethylene glycol) in a preferred amount of 1.5%-6% or Witco's diethanol amide in a preferred amount of 1.0%-7% (depending upon level of required resistance) as mixed into the hydrapulper slurry.

The new linerboard can preferably range from 10 lbs./msf to 100-lbs./msf.

The dissipative linerboard color can also be composed of a powdered color admixture of poly(diallyldimethylammonium chloride) or Carbowax or Diethanol amide/wood fibers or rice paper/starch and adhesives.

The conductive shielding medium can be imparted with evenly dispersed carbon black and can have a preferred basis weight range between 10 lbs./msf to 50 lbs./msf.

Specification and test data were based on the measurements per Electronic Industry Association and ESD Association Standards, NASA, Boeing Aircraft and TAPPI requirements (see Ex. 1).

The dissipative-pigmented colored paper (35) (FIGS. 2, 2B, 2C) can be sized with a sealer to prevent rub off.

A targeted electrical resistance greater than 1.0×10⁷ ohms but less than 1.0×10¹⁰ ohms is preferred. This can be achieved by the addition of approximately 10 to 12% by weight of powered colored dissipative dyes with an admixture of carbon free poly(diallyldimethylammonium chloride) or Carbowax or Diethanol Amide in the wood fiber batch or slurry. The Calgon Polymer 261 is preferred due to the environmental friendly nature of the chemical polymer.

A mixture including, but not restricted to, wood pulp fiber, recycled news print, rags, construction paper, rice paper, water, dissipative colorants (pigments/dyes or combination thereof) and poly(diallyldimethylammonium chloride) or Carbowax or Diethanol Amide and other chemicals can be used in the ESD paper-making process of this invention.

In making this product, a variety of techniques and apparatuses can be employed. For example, the components can be added to a suitable device, e.g., a large blender such as a hydrapulper or beater to insure a homogeneous and equal distribution of the raw materials. The raw materials are blended until a desired, preferably homogeneous, suspension of wood pulp is achieved. The poly(diallyldimethylammonium chloride) insures excellent static dissipative readings in very low relative humidities. Henceforth, the linerboard remains free of carbon.

The consistency (% solids) of the mixture varies depending on the requirements per ESD-S. 11.11-1993 for the final readings desired. For example, the black homogeneous medium or fluted arches used for corrugation requires at least 8% to 10% carbon black powder to obtain outstanding conductive readings as required for excellent high voltage discharge resistance.

The color of the finished paper is determined by the combination of paperboard mixed into the slurry, the combination of specially formulated dissipative colorants used, the amount of the dissipative colorant used and the dwell time that the colorants have with the pulp. Too little of a dwell time can adversely affect the final readings for meeting the dissipative requirements per ESD-S.11.11-1993. The rapid change in momentum of the hydrapulper insures that the dynamic forces break up the raw materials and insure bonding of the formulation to take place.

Dissipative colored homogeneous paper or liners can be attained using the batch method described above or by continuous addition of colorants prior to the formation of the ESD paper. However, the special chemical can enhance the dissipative nature of ESD fiberboard invention.

The homogeneous mixture is pumped from the pulper through a series of holding chests prior to being pumped into the paper machine headbox. The number and size of the holding chests vary depending on the particular design of the paper machine. The headbox uniformly distributes the suspension onto an endless moving screen (wire). The wire and associated equipment forms the fibers into a sheet by enabling the water to drain through the wire. Water drains by gravitational forces and various vacuuming methods, which should employ vacuum air ionization to keep out contaminates.

This area of the paper machine is described as the forming area of the paper machine or, more specifically, the forming table of the Fourdrinier paper machine. Formation is the degree of uniformity of the fibers in the finished rolls of dissipative or conductive paper. The wet, but formed continuous sheet or liner, is then fed through a series of presses where additional water is removed and the continuous sheet is compressed. The majority of the remaining water is evaporated as the sheet contacts a series of steam-heated cylinders called dryer cans.

The dryer section of the paper machine is comprised of two sections separated by a piece of equipment known as a size press. The size press is used to add various surface sizes for the specially formulated dissipative and conductive ESD liners. The continuous sheet or liner of paper exits the size press and enters the last section of dryers where final drying of the paper takes place.

Upon exiting the last section of dryers, the continuous sheet of paper passes through the calender stack. The level of calendering is determined by the roughness or smoothness required for the paperboard. The more the continuous sheet is calendared, the denser and smoother the sheet becomes.

The finished liner is rewound, slit and measured for ESD readings for the special ESD liners. The ESD dissipative fiberboard material will be made into protective sheeting for use in the packaging of electrostatic sensitive devices.

This invention also include certain inventive methods, e.g., providing a homogeneous carbon loaded paperboard medium in continuous roll form which has an electrical resistance of the surface that preferably measures less than 1.0×10³ ohms, providing homogeneous continuous rolled liners with various electrostatic dissipative admixtures of colored dyes and batching the homogeneous mixture as described earlier to obtain desired surface resistance readings, e.g., between 1.0×10⁴ to 1.0×10¹¹ ohms, at less than standard conditions for the static dissipative colored liners.

As discussed above, the product is capable of protecting electronic components and devices from the hazards of electrostatic discharge.

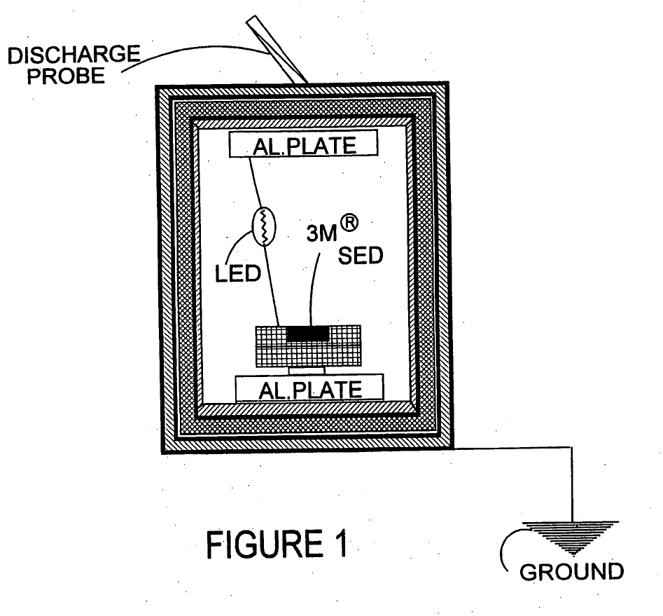

The reference FIG. 1. shows one function of an ESD box on a grounded plane with an event detector by 3M® Company placed into the closed box. The box is subjected to a 1000 volts or greater discharge. The ESD event detector by 3M® will change from clear blue or red in color if the voltage is not shielded from entrance into the box.

The ESD paperboard homogenous medium is carbon loaded and is adhered to the adjacent colored homogeneous dissipative high strength linerboard. This is fully in view per the samples of actual colored dissipative homogeneous liners and medium(s) before the bonding process has taken place (see FIG. 2B).

Heat and starch cause the top (46) and bottom (44) of the medium (28) to bond (FIGS. 2 and 2C) to the underside of the linerboard. The colored static dissipative linerboard (35) (FIGS. 2, 2B & 2C) can be made up of wood pulp, fiber, water, dissipative color(s) & or dyes, pigments, poly(diallyldimethylammonium chloride) or Carbowax or diethanol amide & other chemicals to impart a preferred static dissipative resistance reading between 1.0×10⁷ and 1.0×10¹¹ ohms at standard conditions.

The conductive medium(s) (numbered (30) of FIGS. 2, 2A & 2C) is buried between one or more dissipative linerboards. The color of the finished paper is determined by the combination of fibers used, the combination of specially formulated dissipative colorants used, the amount of the dissipative colorant used and the dwell time the colorants have with the pulp. Too little time can adversely affect the final readings for meeting the dissipative requirements per ESD-S.11.11-1993.

The corrugated conductive medium, as illustrated in cross section of mediums has a wave-like shape known as flutes (FIGS. 2A & 2C). In the corrugated embodiment, the inside and outside dissipative linerboards are adhered to the medium's (FIG. 2A) fluting apex (46) and nadir (44) at opposite ends of each other (28) (FIG. 2C) via a heat and starching process which bonds the fiberboard together.

The medium preferably has a basis weight of 10 lbs./msf to 50 lbs./msf. The conventional weight is about (+/−) 26 lbs./msf for corrugated medium. The conductive medium section view FIG. 2A can be targeted between 18 lbs./msf to 50 lbs./msf.

The corrugated medium can be made up of paperboard that has been mixed into a batch with water and carbon black to achieve a desired surface resistance, e.g., less than 1.0×10³ ohms per ESD-S.11.11-1193.

This can be achieved by admixing approximately 6% to 10% by weight of carbon black powder into the paper pulp in the manufacture of ESD roll stock medium.

The rolls can then be shipped to a corrugated box plant and corrugated into boxes. The advantage is superior graphics and reduced print crush versus a coated process utilized in the ESD corrugated industry, which hinders printing. The substrate medium shall be of either a recycled composition of paperboard with no less than 6% to 10% conductive carbon powder to obtain a reading of less than or equal to 1.0×10³ ohms.

The ESD liner preferably contains less than 8 ppm of reducible sulfur and has static dissipative reading of less than 1.0×10¹¹ ohms as a measurement in resistance at less than a targeted range between 4% through 12% relative humidity. The liners shall be corrugated or laminated and provide the exterior of the package or surface of the ESD paper product(s). In corrugation, the high strength linerboard shall be opposite each other during corrugation. The basic advantages of the more elaborate preferred form of the present ESD fiberboard are retained in a continuously buried shielded medium (30) which provides Faraday Cage shielding and a slower drain to ground due to the dissipative colored liners (35) (FIGS. 2, 2B & 2C).

Conductive surfaces drain charges too quickly and cause “sparking” or “rapid” discharges” when a grounded operator touches an ungrounded open container which is known as a Charged Device Model (CDM) hazard.

The lamination of the buried conductive paperboard (33) can be adhered to a dissipative colored homogenous paperboard (35) to form a linerboard which can be corrugated to a conductivity homogeneous medium (30) or a non treated buried Kraft colored medium (31) to form an alternative ESD corrugated sheet as illustrated in FIG. 2C111 and cross section FIG. 2C11.

The paperboard (36) (FIG. 2C1) can be laminated with a homogeneously conductive paperboard (33), static dissipative paperboard (35) with an adhesive (32) and a polymer film or finish (37).

The potential of conductive particle sloughing or rub off is substantially reduced since the paperboard liners are static dissipative. This is a very hazardous problem since the pins of a circuit board can rub up against coated or carbon loaded dividers or partitions. Conductive carbon particles can bridge the gap of circuit lines and cause a short.

ASTM D-4060 test method is achieved by a 1000 gram wheel rotating at a rate of 70 RPM's that will cause a surface coated conductive liner to lose conductive particles in 10 cycles or less. In this invention, the static dissipative linerboard would not exhibit any conductive particle rub off until it wears entirely through the surface of the linerboard into the homogeneous conductive paperboard (33) or medium (30). The linerboard can be laminated onto dissipative plies (34, 35) of solid fiber to form a rigid non-fluted durable material (FIG. 3) on the attached illustration. The solid fiber (FIG. 3) could be used as dividers requiring no shielding but exhibiting dissipative properties or have a homogeneous shielded (33) (FIG. 3A) paperboard linerboard adhered between dissipative exterior liners (35) and made into non fluted containers or boxes, mailers, bags or shelf liners or mats for static shielding, or a means for draining a charge to ground.

The paperboard could include corrugated cuttings/clippings, virgin pulp or fiber, rags, rice paper, newspaper material, construction paper and other paper products.

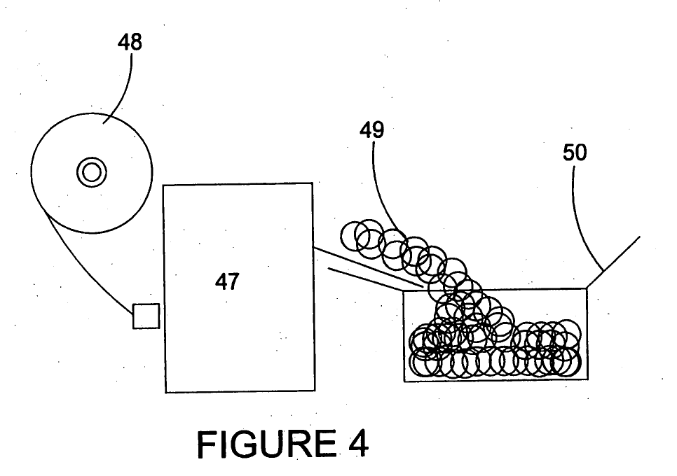

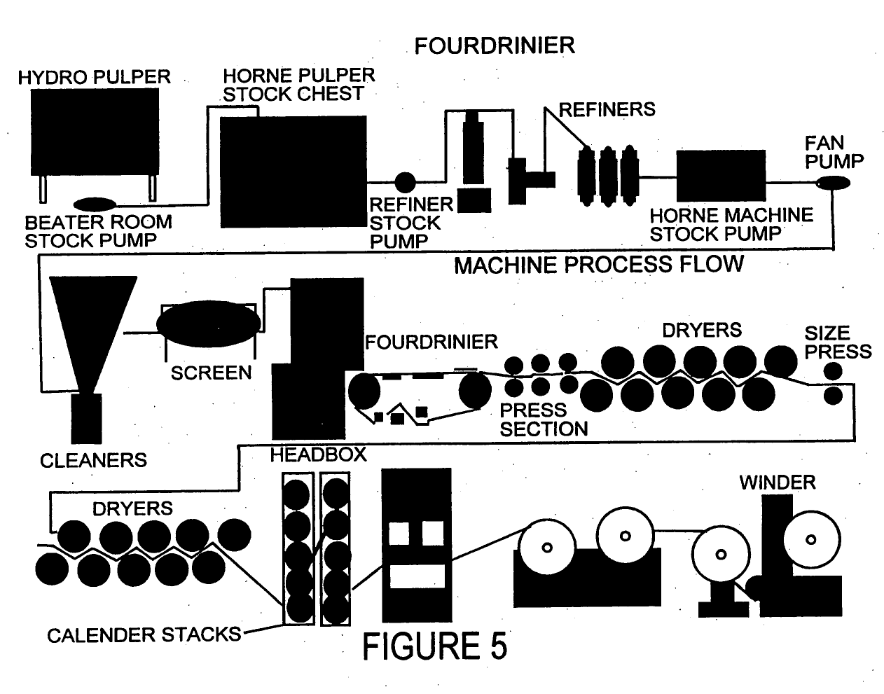

The FIG. 4 illustration shows ESD dissipative liner (48) or black conductive paperboard liner being crumpled up by a pad pack type machine (47) and free falling (49) into an open container (50). For example, if one took a sheet of paper and crushed it with one's hand into a “snow ball-like” shape, it would emulate the process-taking place with the liner. A dozen 8″×11″ paper sheets crushed into a snowball like shape would be a good cushioning material. The ESD paperboard is recyclable and repulpable. It exhibits static dissipative or conductive readings.

This embodiment of the invention is capable of protecting electronic components and devices from the hazards of electrostatic discharge by a fiberboard configuration that incorporates a buried fluted or unfluted shielding paperboard (less than or equal to 1.0×10³ ohms per ESD-S.11.11-1993) that has been adhered together through the corrugation process or lamination process with one or more homogeneous colored dissipative high strength liners.

The liners can have a surface resistance range between a targeted 1.0×10⁷ to 1.0×10¹⁰ ohms at 12%+/−3% relative humidity & 73° Fahrenheit. The linerboard or medium can be used as static safe packaging cushioning material, shelving liners; dividers, in-plant handlers, and specialty static free packaging shielding or dissipative paper bags. Unlike the prior technologies, each individual paperboard component of the fiberboard can be homogeneous throughout the material. This unexpected benefit of the invention affords the fiberboard to be volume resistant for effective static decay results.

In addition, another surprising benefit is that the homogeneous nature of the paperboard can result in a Crypto charge free fiberboard. Unlike the existing layered, laminated and coated linerboards, which can exhibit “Crypto” (charges that are hidden) charges or suppressed charges within corrugated Linerboard(s), solid fiber and medium. Volume Resistance is calculated according to ESD-S. 11.12-1995.

Also, since the dissipative liners can be truly homogeneous and the medium is conductive, the product is not dependent on higher relative humidities such as 50% to function as materials that use Kraft liners on the inside of an ESD shielding container, which experience less than 12% to 15% relative humidity and can exhibit insulative surface resistance readings. The ESD Association requires conditioning for 48 hours at 73 degrees F. @ 12% relative humidity (standard conditions) for testing. Static decay measurements according to EIA-541, Appendix F, should be less than 2.0 seconds at standard conditions for a range of +/−1000 volts to +/−100 volts. The other products may exhibit insulative readings when the relative humidity falls below 12% to 15% for Kraft liner and 23% to 30% for white paper.

The conductive medium, in combination with one of more homogeneous dissipative linerboard(s), can provide an excellent path to ground for the fiberboard invention.

Additional advantages over previous technologies include that the ESD fiberboard is durable; it has carbon free homogeneous electrically static dissipative liners and is gluable. Moreover, the printing options that can be used greatly outweigh coated or layered carbon linerboard.

The versatility of the invention allows it to be made into ESD static shielding boxes, bags, and dividers and packaging materials that are completely recyclable. The invention can have a buried shielding fluted medium under homogeneous liners or be laminated into solid fiber. Special CDM safe dissipative readings are exhibited while excellent static shielding takes place. A container made of the invention can sustain wear without affecting its attractive appearance while exhibiting safe static dissipative surface resistance readings per ESD-S. 11.11-1993.

In other words, unlike existing technologies, this invention can provide a CDM safe material that can be humidity independent while exhibiting superior static shielding, carbon free static dissipative surface liners, and volume resistance. The volume resistance of the fiberboard offers protection from hidden charges or “Crypto” charges.

Since the linerboard is homogeneous, no special gluing considerations of corrugated boxes is required at the manufacturing joint (two paper surfaces are glued together) as required with varnished or carbon loaded ESD liners. The exterior linerboards can be printed with a wider variety of ink lettering and images. Since the conductive shielding paperboard is buried under a carbon free linerboard, the material exhibits a superior resistance to rub off of conductive particle or sloughing. It takes a Teledyne Taper® Abrasion Tester 1000 to 1020 cycles of a 1000 gram wheel as it rotates at 70 revolutions per minute to reach the buried homogeneous carbon medium. This is known as the American Standards for Testing Materials (ASTM) D-4046 test method.

Conductive particles do not bridge the gaps of circuit lines or become wedged in an electronic component to cause a spark when a circuit board rubs against a wall of a partitioned container. The existing conductive ink coated technologies have been known to lose 40% to 50% of their conductive particles in 10 cycles of the above test.

The most favorable buried layered shielded technologies still have trace elements of carbon in their liners that have a potential for sparking.

Because the liner is homogenous, the ESD characteristics are well maintained after severe wear of the other liners since the paperboard is not coated or topically treated. Unlike, surface conductive coated products, this invention does not sacrifice the static shielding after the surface liners become worn, bent or broken at the scorelines. The common practice of removing labels from a box will not make a corrugated container less or dissipative shielding in the event that surface fibers of the outer liners are torn off the face of the box.

For economic considerations and durability, the homogeneous paperboard can be made into varying basis weights to meet required applications. The variety of color options would offer a customer the ability to purchase the fiberboard in a wide spectrum while meeting ESD or company requirements. Since the liners are layered and are homogeneous, weak internal bonding of the paperboard is not a problem.

### EXAMPLES

The test results as illustrated in the “Material Specifications” (see Ex. 1) were conducted to establish the properties relevant to electrostatic protection. An article has appeared in the March 1997 issue of “Packaging Technology & Engineering” as written by the inventor, Robert J. Vermillion, CPP & Certified, ESD Engineer, NARTE.

### Example I

Material Specifications

Static Decay:

I Standard Rate of decay shall be less than 2.0 seconds

II Results: Average 0.4 seconds @ 12% RH 73° F.

III Method: EIA-541, Appendix F, +/−1 Kv to +/−100 v

Surface Resistance in Ohms:

I Standard: Less than 1.0×10¹¹ ohms

II Results: 5.3×10⁶ ohms −4.5×10⁹ ohms

III SHIELDING MEDIUM:

IV Results: 1.0×10² ohms −3.0×10³ ohms

V Method: EOS/ESD S11.11-1993 @ 12% RH 73° F.

Volume Resistance in Ohms-cm.

I Standard: Less than 1.0×10¹¹ ohms-cm

II Results: 5.3×10⁶⁻¹⁰ ohms-cm

III Method: EOS/ESD S11.12-1995 (PROPOSED) @ 12% RH 73° F.

Static Shielding:

I Requirement: Integrity of 3M® Sensor @ 100 Volts for 4 kv & 10 kv

II Results: Passed 4 kv & 10 kv

III Method. 3M® 753-ESD Simulator Unit & 3M® Sensors, Meets EIA-541, appendix E, Capacitive Probe Test

Recyclability:

I Requirement: 100% recyclability to recycling centers

II Results: Requirement Met

III Reference: PAPER REPULPING TESTS-JUNE 1996

CDM Safety:

I Requirement: Pass 3M® Static Event Detector of 87 volts @ 1 Kv

II Results: Passed 10 kv to 3M® Event Detector of 50 volts

III Requirement: Dr. John Kolyer Method, Boeing Aircraft October 1991

Chemical:

I Requirement: <8 PPM (parts per million)

II Found: Reducible Sulfur: 3 PPM

III Reference: Nontarnishing to silver, solder & copper per Tappi T-406

Triboelectric Charging:

I Requirement: MEETS NASA REQUIREMENT

II Results: REQUIREMENT MET

III Reference: MMA-1985-79-REV 2 JUL. 15, 1988 RH GOMPF, PE, Ph.D. NASA & C. L. SPRINGFIELD, NASA CHIEF MATERIALS TESTING BRANCH.

The preferred embodiments of this invention have been specifically described and illustrated to demonstrate its novel features that produce new and unexpected results. It is foreseeable that a person having ordinary skill in the art will envision substitutions, modifications, and changes to the invention's described embodiments, which are within the parameters of the present invention as defined by the following claims.

I claim:

1. A static dissipative paperboard comprising:
at least one static dissipative substance homogeneously dispersed throughout the static dissipative paperboard, wherein the static dissipative paperboard is substantially free of carbon particles.

2. The static dissipative paperboard of claim 1, wherein the static dissipative paperboard has an electrical resistance between about 1×10⁴ and about 1×10¹¹ ohms at a relative humidity of less than or equal to 12 percent.

3. The static dissipative paperboard of claim 1, wherein the static dissipative substance is selected from the group consisting of poly(diallyldimethylammonium chloride), polyethylene glycol, diethanol amide and mixtures thereof.

4. The static dissipative paperboard of claim 1, wherein the static dissipative substance is poly(diallyldimethylammonium chloride) in an amount between about 0.5 and about 7.5 percent by weight.

5. The static dissipative paperboard of claim 1, wherein the static dissipative substance is diethanol amide in an amount between about 1.0 and about 7.0 percent by weight.

6. The static dissipative paperboard of claim 1, wherein the static dissipative substance is polyethylene glycol in an amount between about 1.5 and about 6.0 percent by weight.

7. The dissipative paperboard of claim 1, further comprising an effective color producing amount of a dissipative pigment or dye.

8. The static dissipative paperboard of claim 1, wherein said static dissipative paperboard comprises less than about 8 ppm of reducible sulfur.

9. A fiberboard composition comprising:
at least one conductive paperboard sandwiched between layers of static dissipative linerboard;
an electrically conductive substance substantially homogeneously dispersed throughout said paperboard; and,
a static dissipative substance substantially homogeneously dispersed throughout the static dissipative linerboard.

10. The fiberboard of claim 9, wherein said conductive paperboard has an electrical resistance equal to or less than about 1×10³ ohms.

11. The fiberboard of claim 9, wherein said static dissipative linerboard has an electrical resistance between about 1×10⁴ and 1×10¹¹ ohms at a relative humidity of less than twelve percent.

12. The fiberboard of claim 9, wherein said conductive paperboard sandwiched between said layers of static dissipative linerboard has a wave shape.

13. The dissipative paperboard of claim 9, wherein the static dissipative substance is selected from the group consisting of poly(diallyldimethylammonium chloride), polyethylene glycol, diethanol amide and mixtures thereof.

14. The dissipative paperboard of claim 9, wherein the static dissipative substance is poly(diallyldimethylammonium chloride) in an amount between about 0.5 and about 7.5 percent by weight of said linerboard.

15. The dissipative paperboard of claim 9, wherein the static dissipative substance is diethanol amide in an amount between about 1.0 and about 7.0 percent by weight of said linerboard.

16. The dissipative paperboard of claim 9, wherein the static dissipative substance is polyethylene glycol in an amount between about 1.5 and about 6.0 percent by weight of said linerboard.

17. The fiberboard of claim 9, wherein said electrically conductive substance is about 6% to about 10% by weight of said conductive paperboard.

18. The fiberboard of claim 9, wherein said electrically conductive substance is carbon particles.

19. The fiberboard of claim 9, wherein said electrically conductive substance is carbon black.

20. The static dissipative linerboard of claim 9, wherein said static dissipative linerboard comprises less than about 8 ppm of reducible sulfur.

21. The static dissipative linerboard of claim 9, wherein said conductive paperboard has a basis weight range between about 10 lbs/msf and about 50 lbs/msf.

22. Static dissipative paperboard comprising a static dissipative substance homogeneously dispersed throughout said paperboard, said static dissipative paperboard has an electrical resistance between about 1×10⁴ and about 1×10¹¹ ohms at a relative humidity of less than or equal to 12 percent.

23. The static dissipative paperboard of claim 22, wherein the static dissipative substance is selected from the group consisting of poly(diallyldimethylammonium chloride), polyethylene glycol, diethanol amide and mixtures thereof.

24. The static dissipative paperboard of claim 22, wherein the static dissipative substance is poly(diallyldimethylammonium chloride) in an amount between about 0.5 and about 7.5 percent by weight.

25. The static dissipative paperboard of claim 22, wherein the static dissipative substance is diethanol amide in an amount between about 1.0 and about 7.0 percent by weight.

26. The static dissipative paperboard of claim 22, wherein the static dissipative substance is polyethylene glycol in an amount between about 1.5 and about 6.0 percent by weight.

27. The static dissipative paperboard of claim 22, further comprising an effective color producing amount of a dissipative pigment or dye.

28. The static dissipative paperboard of claim 22, wherein said static dissipative paperboard is adhered to a conductive paperboard on an exposed face thereof.

29. The static dissipative paperboard of claim 22, wherein said static dissipative paperboard is linerboard.

30. The static dissipative paperboard of claim 22, wherein said static dissipative paperboard comprises less than about 8 ppm of reducible sulfur.

31. A conductive paperboard comprising a conducting material homogeneously dispersed throughout the paperboard, said paperboard having an electrical resistance of less than or equal to about 1×10³.

32. The conductive paperboard of claim 31, wherein said conducting material is carbon particles.

33. The conductive paperboard of claim 31, wherein said conducting material is carbon black.

34. The conductive paperboard of claim 33, wherein said carbon black comprises from about 6% to about 10% by weight of said conductive paperboard.

35. The conductive paperboard of claim 31, wherein said conductive paperboard has a basis weight range between about 10 lbs/msf and about 50 lbs/msf.

36. A method for making recyclable fiberboard for use in protecting electrostatically sensitive devices from the hazards of electrostatic discharge comprising the steps of:
(a) providing a conductive paperboard layer having an electrical resistance of less than or equal to about 1×10³ ohms;
(b) providing static dissipative linerboard having electrical resistance of between about 1×10⁴ to about 1×10¹¹ ohms at twelve percent relative humidity; and,
(c) adhering said static dissipative linerboard to at least one side of said conductive paperboard through a heat and starching process.

37. The method of claim 36, wherein said conductive paperboard layer has a wave shape.

38. The method of claim 36, wherein said conductive paperboard layer is in continuous roll form.

39. The method of claim 37, wherein said static dissipative linerboard is adhered to the apexes and nadirs on both sides of the wave shaped conductive paperboard.

40. The method of claim 36, wherein said static dissipative linerboard is adhered to both sides of said conductive paperboard.

41. The method of claim 36, wherein said conductive paperboard layer comprises carbon black in an amount ranging from about 6% to about 10% by weight.

42. The method of claim 36, wherein said conductive paperboard has a basis weight range between about 10 lbs/msf and about 50 lbs/msf.

43. The method of claim 36, wherein said conductive paperboard is prepared by batch mixing paper pulp and carbon black in water.

44. The static dissipative linerboard of claim 36, wherein the static dissipative linerboard comprises a static dissipative substance selected from the group consisting of poly(diallyldimethylammonium chloride), polyethylene glycol, diethanol amide and mixtures thereof.

45. The static dissipative linerboard of claim 36, wherein the static dissipative linerboard comprises from about 0.5 to about 7.5 percent by weight.

46. The static dissipative linerboard of claim 36, wherein the static dissipative linerboard comprises from about 1.0 to about 7.0 percent by weight.

47. The static dissipative linerboard of claim 36, wherein the static dissipative linerboard comprises from about 1.5 to about 6.0 percent by weight.

48. The static dissipative linerboard of claim 36, further comprising an effective color producing amount of a dissipative pigment or dye.

49. A fiberboard composition comprising:
at least one conductive paperboard, said conductive paperboard has an electrical resistance equal to or less than about 1×10³ ohms and a basis weight range between about 10 lbs/msf and about 50 lbs/msf;
an electrically conductive substance substantially homogeneously dispersed throughout said paperboard;
at least one static dissipative linerboard, said static dissipative linerboard has an electrical resistance between about 1×10⁴ and 1×10¹¹ ohms at a relative humidity of less than twelve percent and less than about 8 ppm of reducible sulfur; and,
a static dissipative substance substantially homogeneously dispersed throughout the static dissipative linerboard.

50. The dissipative paperboard of claim 49, wherein the static dissipative substance is selected from the group consisting of poly(diallyldimethylammonium chloride), polyethylene glycol, diethanol amide and mixtures thereof.

51. The fiberboard of claim 49, wherein said conductive paperboard layer comprises carbon black in an amount ranging from about 6% to about 10% by weight.

52. A conductive paperboard comprising from about 6% to about 10% by weight carbon black dispersed throughout the paperboard, said paperboard having an electrical resistance of less than or equal to about 1×10³ and a basis weight range between about 10 lbs/msf and about 50 lbs/msf.

53. A method for making recyclable fiberboard for use in protecting electrostatically sensitive devices from the hazards of electrostatic discharge comprising the steps of:
(a) providing a wave shaped conductive paperboard layer having an electrical resistance of less than or equal to about 1×10³ ohms, said conductive paperboard layer comprises carbon black in an amount ranging from about 6% to about 10% by weight and has a basis weight range between about 10 lbs/msf and about 50 lbs/msf;
(b) providing linerboard having dissipative electrical resistance of between about 1×10⁴ to about 1×10¹¹ ohms at twelve percent relative humidity; and,
(c) adhering linerboard to at least one side of said conductive paperboard through a heat and starching process.

54. The method of claim 53, wherein said linerboard is adhered to the apexes and nadirs on both sides of the wave shaped conductive paperboard.

55. The method of claim 53, wherein said conductive paperboard is prepared by batch mixing paper pulp and carbon black in water.

56. The static dissipative linerboard of claim 53, wherein the static dissipative linerboard comprises a static dissipative substance selected from the group consisting of poly(diallyldimethylammonium chloride), polyethylene glycol, diethanol amide and mixtures thereof.
